(19) United States
(12) Patent Application Publication
(10) Pub. No.: US 2012/0046960 A1
(43) Pub. Date: Feb. 23, 2012

(54) METHODS AND SYSTEMS FOR SOCIALIZING AFFILIATE MARKETING

(76) Inventor: Brenden R. Salta, Huntington, MD (US)

(21) Appl. No.: 12/861,305

(22) Filed: Aug. 23, 2010

(51) Int. Cl. G06Q 30/00

(52) U.S. Cl. 705/1.1

(57) ABSTRACT

Embodiments consistent with the invention provide systems and methods for accepting a web merchant link from a user who is not an affiliate of the web merchant, and returning a substitute link that links to an intermediary website. When a person uses the substitute link, for example through on-line socialization, the intermediary website directs them to the web merchant's website in a manner that provides affiliate marketing credit to the affiliate represented by the intermediary website. The affiliate keeps track of the association between the redirected person and the user who created the substitute link, and credits affiliate marketing benefits earned in conjunction with the activities of the redirected person (e.g. commission) to the user who created the substitute link. The benefits may also be credited to a person or organization designated by the user.

### FIELD OF THE INVENTION

This application relates generally to online affiliate marketing and more particularly, to online affiliate marketing for individuals.

### BACKGROUND

Many web businesses use affiliate marketing as a way of promoting their website and selling products and services online. Affiliate marketing may be thought of as an online version of the practice of paying finder's fees for the introduction of new customers to a web business. An “affiliate” is someone who joins or registers with a web merchant's affiliate marketing program and is rewarded for referring or directing visitors, subscribers and/or customers to the web business. In various affiliate marketing programs, the finder's fee compensation may be based on a certain value for each visit (often known as Pay-per-click), for each registrant (often known as Pay-per-lead), or a commission for each customer purchase or sale (often known as Pay-per-Sale).

An affiliate typically must have a website in order to join and participate in an affiliate marketing program. Affiliate marketing is conducted via the affiliate's web pages, such as a page on the affiliate's niche website, where the affiliate seeks to attract a target audience that is interested in the niche information and that will include customers for the web merchant's business. An affiliate receives benefits, typically commissions, for customers that interact with a web business via a special affiliate link (e.g., an affiliate hyperlink or an affiliate URL or another linked control or linked feature) on the affiliate's web page. The affiliate links and affiliate linked features are different from normal links and features in that they allow the web business to identify the affiliate's web page as the source of the link or control and consequently to accurately pay to the affiliate any commissions generated. To drive a customer to the website of the web merchant and earn commission off of the customer, the affiliate places the special affiliate links and affiliate features (such as linked controls, linked banners, linked widgets, embedded shopping carts, etc.) on the affiliate's website to advertise the web merchant's products and/or services. When an internet user on the affiliate's web page interacts with an affiliate link or affiliate feature (e.g., clicks on a link) and subsequently completes a commission-generating activity on the website of the web merchant's business, then the affiliate earns a commission. As noted, an individual wishing to act as an affiliate needs to have a website in order to sign up for and participate in a conventional affiliate marketing program.

### SUMMARY OF THE INVENTION

In accordance with embodiments of the invention, systems and methods are provided that allow a user to participate in an affiliate marketing program without having a website or web page. in some embodiments, systems and methods are provided that supply a user with a link that generates affiliate benefits, such as commissions, for the user.

In one embodiment consistent with the invention, systems and methods are provided for affiliate marketing, the systems and methods including components and stages for performing operations including registering an intermediary entity as an affiliate in an affiliate marketing program of a business; obtaining, from a user, a link that links to a website of the business; creating a substitute link for the link, wherein the substitute link links to an intermediary website associated with the intermediary entity; directing, by the intermediary website and to the website of the business, a client request initiated using the substitute link; and crediting to the user, by the intermediary entity, an affiliate benefit earned in conjunction with the directing according to the affiliate marketing program.

In another embodiment consistent with the invention, systems and methods are provided for enabling a user to participate in an affiliate marketing program of a web business, the systems and methods including components and stages for performing operations including creating an affiliate to the web business according to the affiliate marketing program, wherein the affiliate includes an intermediary website; supplying a substitute link that links to the intermediary website, wherein the substitute link is associated with the user and with the web business; forwarding, by the intermediary website, a client that is using the substitute link to the web business; receiving, by the affiliate and from the web business, an affiliate benefit generated in association with the forwarding of the client; and attributing the affiliate benefit to the user that is associated with the substitute link.

In yet another embodiment consistent with the invention, systems and methods are provided for affiliate marketing by a user, the systems and methods including components and stages for performing operations including obtaining a link that links to a website of a business; providing the link and information identifying an originating user to an affiliate of the business, wherein the affiliate includes an intermediary website; receiving from the affiliate a substitute link that links to the intermediary website, wherein the substitute link is associated with the originating user; distributing the substitute link to an internet user; and receiving, from the affiliate, credit for an affiliate benefit caused by the internet user utilizing the substitute link to interact with the website of the business; wherein the originating user is not the affiliate of the business.

Additional features and advantages of the invention will be set forth in part in the description which follows, and in part will be obvious from the description, or may be learned by practice of the invention. The features and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate several embodiments of the invention and together with the description, serve to explain the principles of the invention.

### BRIEF DESCRIPTION OF THE DRAWINGS

FIG. 1 is a block diagram of an exemplary system for affiliate marketing consistent with embodiments of the invention;

FIG. 2 is a flow chart of an exemplary process for creating a link for affiliate marketing consistent with embodiments of the invention;

FIG. 3 is a flow chart of another exemplary process for creating a link for affiliate marketing consistent with embodiments of the invention;

FIG. 4 is flow chart of an exemplary process for utilizing a link for affiliate marketing consistent with embodiments of the invention;

FIG. 5 is flow chart of another exemplary process for utilizing a link for affiliate marketing consistent with embodiments of the invention;

FIG. 6 illustrates exemplary data structures for organizing information associated with an affiliate marketing link consistent with embodiments of the invention; and

FIG. 7 is a block diagram of an exemplary computing system that may be used to implement embodiments consistent with the invention.

### DESCRIPTION OF THE EMBODIMENTS

Reference will now be made in detail to exemplary embodiments of the invention, examples of which are illustrated in the accompanying drawings. Wherever convenient, the same reference numbers will be used throughout the drawings to refer to the same or like parts.

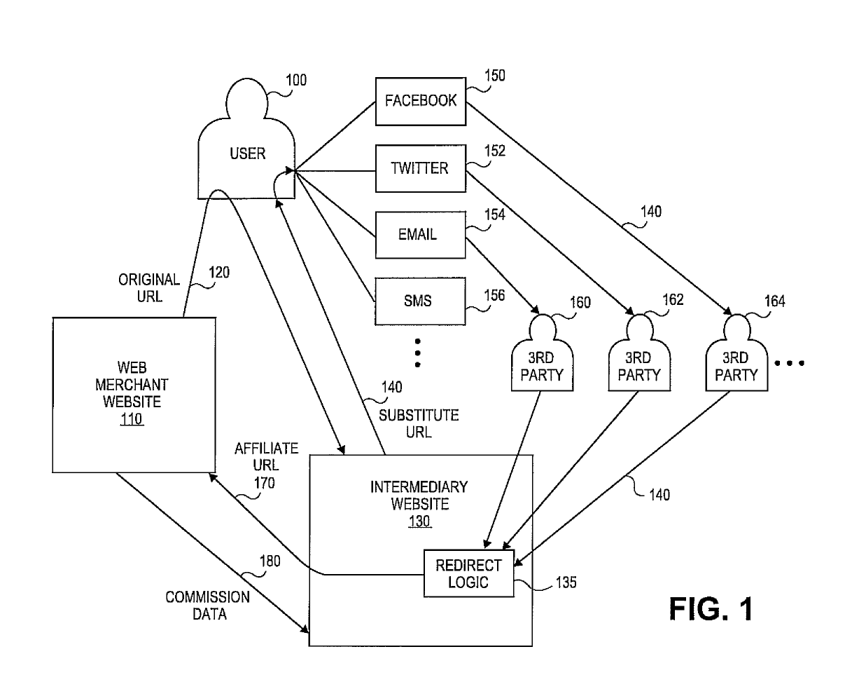

FIG. 1 is a block diagram of an exemplary system consistent with embodiments of the invention. The exemplary system may be utilized by a user 100 to earn affiliate marketing benefits, (such as cash and cash equivalents, for example, commissions, credits, discounts, coupons, etc.) from a web merchant website 110 without formally registering and joining the affiliate marketing program of a business, such as web merchant website 110, and without necessarily using a website maintained by user 100.

In the embodiment shown, a user 100 may interact with a web merchant website 110 and an intermediary website 130, using, for example, a personal computer, laptop computer, or smart phone equipped with a web browser and communicating via the internet (not shown). To market, advertise, or promote a product or service offered by web merchant website 110, user 100 may obtain an original URL 120 from web merchant website 110 that points to a web page describing the product or service. User 100 may obtain original URL 120 by, for example, copying original URL 120 on a computer.

User 100 may then access intermediary website 130 and provide original URL 120 to intermediary website 130. In various embodiments, intermediary website 130 may be implemented with a server computer connected to the Internet. In one embodiment, intermediary website 130 has previously been registered, (for example, manually by an operator or automatically via a software script or application), as an affiliate in the affiliate marketing program of web merchant website 110. In another embodiment, intermediary website 130 proceeds to register as an affiliate in the affiliate marketing program of web merchant website 110 after receiving original URL 120, which identifies web merchant website 110. In either embodiment, intermediary website 130 may generate a substitute URL 140 that points or links to intermediary website 130 and may store information associating substitute URL 140 with user 100, original URL 120, and intermediary website 130's affiliate program membership with web merchant website 110.

Intermediary website 130 also provides substitute URL 140 to user 100 for distribution. In some embodiments, substitute URL 140 may be a short URL that is convenient to distribute to other people, especially, for example, in text messages (SMS messages) and other mediums where the number of characters per message is limited. In some embodiments, substitute URL 140 may be descriptive of the web page from web merchant website 110 that original URL 120 points to. For instance, if original URL 120 points to a web page describing a Garmin Nuvi™ GPS navigation device for sale from web merchant website 110, then substitute URL 140 may contain the word “nuvi.”

Although substitute URL 140 points to intermediary website 130, in various embodiments consistent with the invention, substitute URL 140 is used to transfer anyone using it (e.g., clicking on it) from intermediary website 130 to the appropriate web page of web merchant website 110 corresponding to original URL 120. Preferably, this transfer is performed in a manner that is not noticeable to the user of substitute URL 140.

After user 100 receives substitute URL 140 from intermediary website 130, user 100 may distribute substitute URL 140 to others, such as third party 160, third party 162, and third party 164 shown in the example of FIG. 1. A third party internet user 160, 162, 164 may be a person utilizing a computer running a web browser, which, as is well known in the art, acts as a client to a web server, such as a web server for intermediary website 130. In addition, user 100 may utilize substitute URL 140 personally. Typically, user 100 will describe, support, promote, and/or recommend the product or service associated with substitute URL 140 when distributing it to others.

User 100 may distribute or disseminate substitute URL 140 by any means, including social networking sites, electronic communications, face-to-face communications, etc. For example, as shown in FIG. 1, user 100 may place substitute URL 140 on the wall of their homepage on the Facebook™ social networking site 150, where a third party user 164 may click on it to be indirectly taken to web merchant website 110. For other examples, user 100 may place substitute URL 140 in a tweet message sent via the Twitter social messaging site 152, so that a third party recipient 162 may click on it using a browser on a laptop computer. Or, user 100 may place substitute URL 140 in an email message 154, where a third party recipient 160 may click on it from a mobile device, such as a smart phone. Or, user 100 may place substitute URL 140 in an SMS (text) message 156 sent from a mobile device, such as a cell phone, where a third party recipient may click on it. Similarly, user 100 may verbally or via a handwritten note provide substitute URL 140 to a third party user, who may later type it into a web browser.

In addition, third party users 160, 162, 164, may further disseminate substitute URL 140 to other third parties, using any of the means mentioned above, or any other desired means.

As shown in the exemplary embodiment of FIG. 1, when a third party user 160, 162, 164 is interested in the product or service associated with substitute URL 140, the third party user may utilize substitute URL 140 (e.g., by clicking on it or typing it into the address bar of a web browser), which initially directs third party user 160, 162, 164 to intermediary website 130. In this embodiment, the third party user's browser acts as a client, sending a client request for a web page to a web server associated with intermediary website 130, as is well known in the art.

In the embodiment shown, when intermediary website 130 receives a web page request from a client using substitute URL 140, redirect logic 135 utilizes an affiliate URL 170 to direct or forward third party users 160, 162, 164 to the appropriate page of web merchant website 110. In some embodiments, the functioning of redirect logic 135 is transparent to third party users 160, 162, 164, so that they do not typically notice that redirection occurs. In the embodiment shown, third party users 160, 162, 164 end up accessing web merchant website 110 via affiliate URL 170 after utilizing substitute URL 140.

Affiliate URL 170 conforms to the format required by the affiliate marketing program of web merchant website 110 (of which intermediary website 130 is an affiliate member) so that intermediary website 130 (and ultimately user 100) is credited for any commissions generated by third party users 160, 162, 164. In one embodiment, intermediary website 130 generates and stores affiliate URL 170 at the same time substitute URL 140 is generated. In other embodiments, affiliate URL 170 may be generated when a web page request using substitute URL 140 is received.

As is known in the art, web merchant website 110 keeps track of commission-generating events performed by third party users 160, 162, and 164, and periodically provides earned affiliate benefits information, such as commission data 180, and earned commission funds to the affiliate entity identified by affiliate URL 170. In this example, intermediary website 130 is registered as the affiliate associated with affiliate URL 170. In some embodiments consistent with the invention, intermediary website 130 may provide all or a portion of the commission funds generated from substitute URL 140 to user 100. In other embodiments, intermediary website 130 may provide all or a portion of the commission funds generated from substitute URL 140 to a recipient designated by user 100, such as a charitable organization. In yet other embodiments, intermediary website 130 may retain a portion of the commission funds as compensation for services provided to user 100.

One of ordinary skill will recognize that the system depicted in FIG. 1 is designed for clarity of explanation and that components, subsystems, and entities may be added to, deleted from, or modified in the system depicted in FIG. 1 without departing from the scope of the invention. For example, a multitude of users like user 100 and a multitude of web merchant websites like web merchant website 110 may be added. Similarly, multiple intermediary websites like intermediary website 130 may be employed within the scope of the invention.

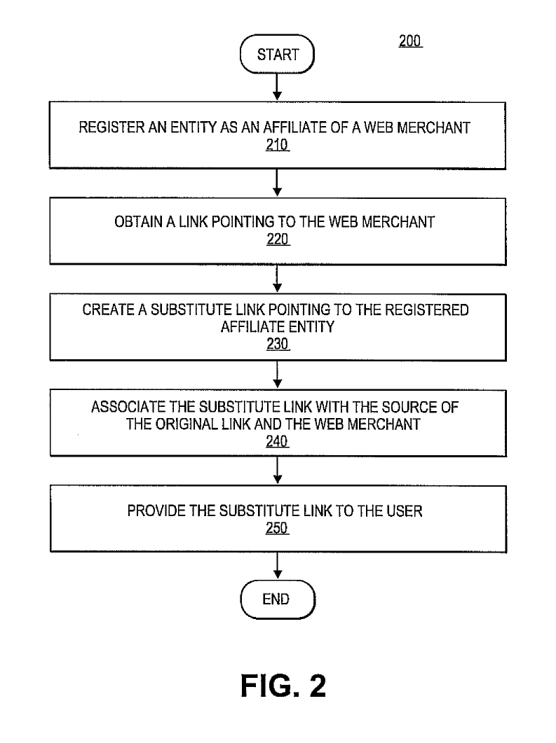

FIG. 2 is a flow chart of an exemplary process 200 for creating a link for affiliate marketing consistent with embodiments of the invention. In various embodiments, process 200 may enable a user who does not have a website, and/or does not register with an affiliate marketing program to nonetheless receive commissions and other benefits from an affiliate marketing program(s). In certain embodiments, process 200 may be implemented using an intermediary website 130 in a system as shown in FIG. 1. FIG. 1 is not intended to be limiting—for example, multiple users like user 100 may be served by an intermediary website 130. In other embodiments, process 200 may be implemented using a computing system not included in intermediary website 130. In yet other embodiments, process 200 may be implemented using more than one website like intermediary website 130.

As shown in the embodiment of FIG. 2, process 200 begins when an entity, such as intermediary website 130, is registered as an affiliate in the affiliate marketing program of a web business, which typically has a website such as web merchant website 110 (stage 210). As a registered affiliate, intermediary website 130 is entitled to receive commissions for commission-generating events performed by customers (e.g., third party users 160, 162, 164), that use an affiliate-identifying link to access the web merchant's website 110.

In stage 220, process 200 obtains a link, such as original URL 120, linking to a web merchant; for instance, a link pointing to a product webpage on the website 110 of the web merchant. In one embodiment, the link is provided by a user 100 to intermediary website 130. In other embodiments, the link may be obtained by some other means, such as by a software application that collects web merchant URLs according to parameters (e.g., product or service descriptions) supplied by a user. In some embodiments, intermediary website 130 also collects identification information, such as an email address, from a user the first time that the user supplies a link. In various embodiments, the identification information may be used to direct future commission payments to the user.

Using the link pointing to the web merchant as an input, process 200 next creates a substitute link, such as substitute URL 140, that points to the entity registered as the affiliate, such as intermediary website 130 (stage 230). In some embodiments where the link is a URL, the substitute URL may be characterized by having a small number of characters, which may be useful because a short URL is easier and less error-prone to type in, write down, and remember, and also fits better where space is limited, such as in text messages.

At stage 240, process 200 associates the substitute link with the source that supplied the original link obtained in stage 220, such as user 100, and with the web merchant to which the original link points. In certain embodiments, this association between the substitute link and the user may be used to direct commission funds to the user or to a designee, and the association between the substitute link and the web merchant may be used to forward or direct users of the substitute link from the entity registered as the affiliate, such as intermediary website 130, to the web merchant, e.g., to the web merchant's website 110. In some embodiments, a representation of the associations between the substitute link, the user, and the web merchant may be stored in a data structure, such as a data base.

The final stage 250 of process 200 provides the substitute link that was created to the user associated with the original link pointing to the web merchant. In one embodiment, the substitute link, such as substitute URL 140, is supplied to user 100, who supplied the original link, such as original URL 120, to process 200. As noted with respect to the embodiment of FIG. 1, user 100 may subsequently supply the substitute link to other users.

One of ordinary skill will recognize that stages may be added to, deleted from, modified, or reordered in process 200 without departing from the scope of the invention. For example, stages 210 and 220 could be reversed in order, such that process 200 registers the intermediary website as an affiliate after determining who the web merchant is from the link obtained, for example, from a user.

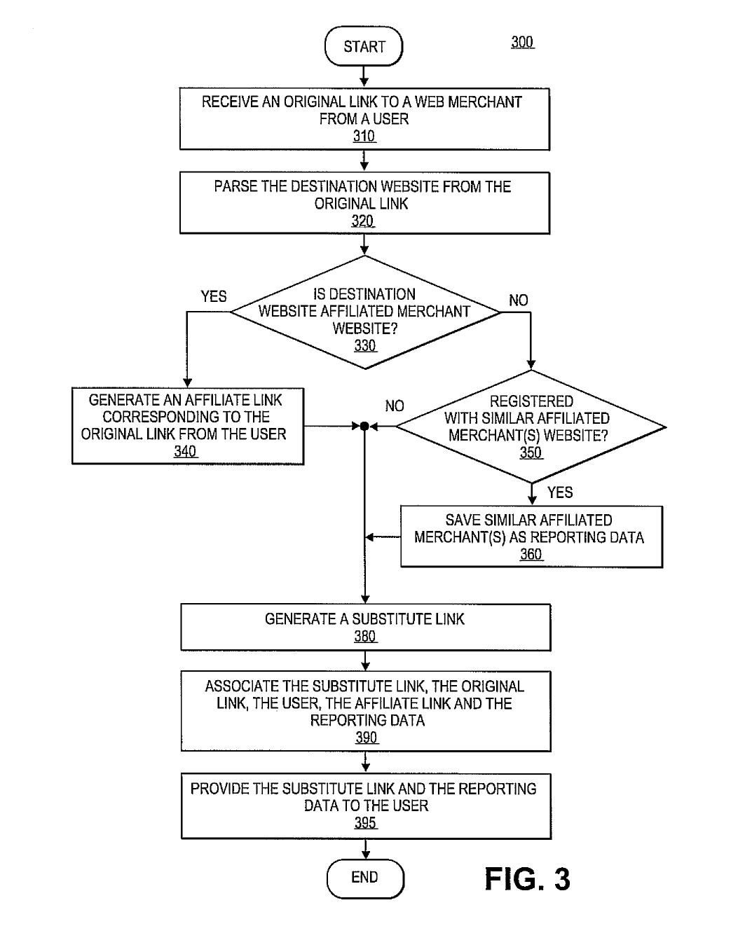

FIG. 3 is a flow chart of another exemplary process 300 for creating a link for affiliate marketing consistent with embodiments of the invention. The embodiment illustrated in process 300 provides additional details regarding implementing various steps of process 200 shown in FIG. 2. In certain embodiments, process 300 may be implemented using an intermediary website 130 in a system as shown in FIG. 1. In other embodiments, process 300 may be implemented using a computing system not included in intermediary website 130.

As shown in the embodiment of FIG. 3, process 300 begins by receiving an original link to a web business, such as original URL 120, from a user, such as user 100, who would like to share the original link with others and earn affiliate marketing benefits (stage 310). In some embodiments, the user may provide the link by typing it in via a website form, hosted, for example, on intermediary website 130. In other embodiments, the user may use an application programming interface (API), for example, on intermediary website 130, which obtains the link by communicating with an application controlled by the user.

Next, process 300 parses the destination website from the original link (stage 320). For example, in a case where the original link pointing to a Garmin Nuvi™ is: “http://www.amazon.com/gp/product/B000H49LXQ?ie=UTF8&linkCode=as2&camp=1789&creative=9325&creativeASIN=B000H49LXQ,” parsing this link yields “amazon.com” as the destination website.

At stage 330, process 300 determines whether the destination website from the original link is an affiliated merchant website. For example, if the destination website is “amazon.com,” then process 300 may process a data structure containing information regarding the web merchant websites whose affiliate marketing plans have been joined, such as a table or list of affiliated merchant websites, and determine whether “amazon.com” is listed in the data structure. In certain embodiments, the affiliate marketing programs of many different web merchants may have been joined prior to execution of process 300, such that the data structure may contain hundreds, or even thousands, of entries for affiliated web merchant websites.

If the destination website is an affiliated merchant website (stage 330, Yes), then process 300 proceeds to stage 340 and generates an affiliate link corresponding to the original link received from the user. In some embodiments, an affiliate link, such as affiliate URL 170, may be used to forward third parties from an intermediary website 130 to an affiliated merchant's website 110. The affiliate link contains information identifying the registered affiliate associated with process 300, such as intermediary website 130, and also contains information from the original link, such as information directing a browser to a web page selling a specific product or service within the affiliated merchant's website.

In one embodiment, to generate the affiliate link, process 300 uses information stored about the affiliated merchant, such as information regarding an affiliate ID assigned to the registered affiliate. For instance, using the “amazon.com” example, an affiliate link may be generated by looking up stored information about the affiliate ID assigned by the amazon.com affiliate marketing program (e.g., “edeem-20”) and adding it to the original link. For instance, a “tag” field may be used to denote the affiliate ID, and the generated affiliate deep link may: “http://www.amazon.com/gp/product/B000H49LXQ?ie=UTF8&tag=edeem-20&linkCode=as2&camp=1789&creative=9325&creativeASIN=B000H49LXQ.” In this example, because the affiliate link identifies “edeem-20” as the registered affiliate, the affiliated merchant (amazon.com) will credit any commissions generated from the use of the affiliate link to affiliate “edeem-20.”

Referring again to stage 330, if the destination website is not an affiliated merchant website (stage 330, No), then process 300 proceeds to stage 350 and determines whether the system is registered or associated with any similar affiliated merchant(s). In one embodiment, this stage may be implemented by searching a data structure, such as a database, for affiliated merchants that have characteristics similar to the characteristics for the destination website merchant's characteristics. For example, if the destination website is a book-selling website, then process 300 may query a database of affiliated merchants for those that are classified as types of book sellers.

If there are not any similar affiliated merchants) (stage 350, No), then process 300 proceeds to stage 380. If, on the other hand, there is at least one similar affiliated merchant (stage 350, Yes), then process 300 proceeds to stage 360. In stage 360, process 300 saves information describing the similar affiliated merchant(s) as reporting data, and proceeds to stage 380.

As shown in the exemplary embodiment of FIG. 3, stage 380 may be entered from stage 340, stage 350, or stage 360. In stage 380, process 300 generates a substitute link, for example a substitute URL 140. In certain embodiments, the substitute link references a forwarding website that is registered as an affiliate in one or more affiliate marketing programs, such as intermediary website 130. In some embodiments, the substitute link may be a shortened link, which is more convenient to circulate and use than the full-length original link.

Next, process 300 associates the substitute link that was generated, the original link, the user, the affiliate link (if one was generated), and the reporting data (if any was created) with each other (stage 390). In one embodiment, a searchable or query-capable data structure, such as a database, may be used to store the substitute link that was generated, the original link, the user, the affiliate link (if one was generated), and the reporting data (if any was created) in association with each other, for example, as a row in a database.

The final stage of process 300 provides the substitute link and the reporting data (if any) to the user that provided the original link (stage 395). In one embodiment, process 300 may provide the substitute URL on a web page GUI as a character string that the user may cut and paste into emails, text messages, social networking pages, etc. In another embodiment, process 300 may provide the substitute URL as an output parameter of an API. The user may share the substitute link with other users, who may in turn share the substitute link, and so on. In yet other embodiments, the substitute link may be provided automatically to third party users, for example, to third party users on a mailing list provided by the user who supplied the original link.

In cases where the substitute link is accompanied by reporting data indicating similar affiliated merchant websites in stage 395, some embodiments may provide the user with information indicating that the web merchant associated with the original link is not an affiliated merchant and consequently, the user cannot earn commissions or other benefits. Those embodiments may also provide the user with information indicating that creating substitute links instead to one or more of the similar affiliated web merchant(s), as indicated in the reporting data, offers the opportunity to participate in an affiliate marketing program and earn benefits from the similar affiliated web merchant(s).

One of ordinary skill will recognize that stages may be added to, deleted from, reordered, and/or modified in process 300 without departing from the scope of the invention. For example, stage 360 may be deleted, and a registration stage may be substituted. In such a substitute registration stage, process 300 may register as an affiliate in an affiliate marketing program offered by the destination website.

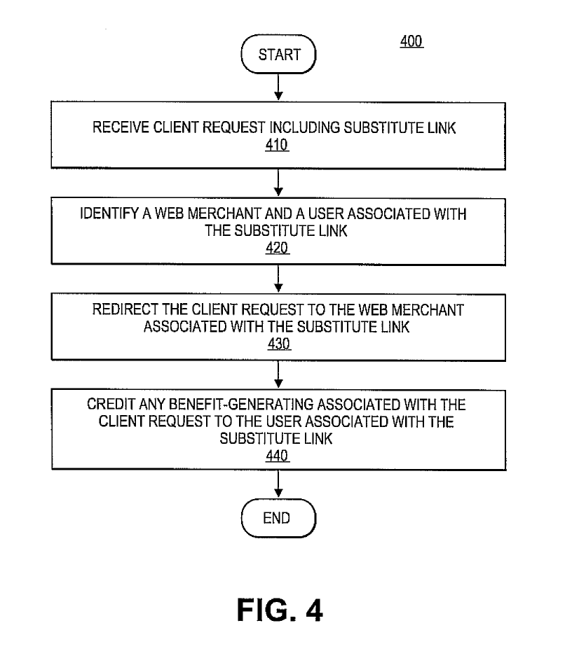

FIG. 4 is flow chart of an exemplary process 400 for utilizing a link for affiliate marketing consistent with embodiments of the invention. In various embodiments, process 400 may enable a user who does not have a website, and/or does not register with an affiliate marketing program to receive commissions from the affiliate marketing program when people use a link created on behalf the user. In certain embodiments, process 400 may be implemented using an intermediary website 130 in a system as shown in FIG. 1. In other embodiments, process 400 may be implemented using a computing system not included in intermediary website 130.

As shown in FIG. 4, process 400 begins by receiving a client request including a substitute link, such as a substitute URL 140 (stage 410). In some embodiments, the client request may be received, for example, from an Internet user, (such as third party user 164), who clicked on the substitute link causing a web page request to a server associated with the substitute link, such as a server implementing intermediary website 130.

At stage 420, process 400 identifies a web merchant and a user associated with the substitute link. In some embodiments, process 400 may perform stage 420 by using the substitute link, such as substitute URL 140, in a query to a database that stores information associating the substitute link with the web merchant, (such as the business operating web merchant website 110), as well as storing other information. In one embodiment, the query returns the stored information about the web merchant, including, for example, a link to the web merchant's web site.

At stage 430, process 400 redirects the client request to the web merchant associated with the substitute link. In some embodiments, process 400 may perform stage 430 by using the substitute link to query a database and retrieve an associated affiliate link stored in a database, such as affiliate URL 170. In other embodiments, process 400 may perform stage 430 by dynamically generating an affiliate link, such as affiliate URL 170, in response to the client request; where the affiliate link is constructed based on stored information about the user who created the substitute link and stored information about the web merchant. In both of these embodiments, the affiliate link points to the web merchant, for example, by pointing to a web page on web merchant website 110, and the affiliate link is used to redirect the browser that sent the client request received in stage 410. In some embodiments, stages 410, 420 and 430 may be performed by redirect logic 135 implemented in software or firmware on a computing system associated with intermediary website 130.

At stage 440, process 400 credits any benefit-generating activity associated with the redirected client request to the user associated with the substitute link. In one embodiment, process 400 may receive data, such as benefits tracking reports, earned affiliate benefits statistics, or commission data 180, from a web merchant and analyze the data to determine the amount of benefits, (e.g., commission or merchandise awards) generated in association with a substitute link, such as substitute URL 140, that was directed (e.g., using an affiliate URL 170) to the web merchant's website. In this embodiment, process 400 may match the substitute link to a user that instigated its creation, and credit the benefits to that user.

In another embodiment, stage 440 may track subsequent affiliate-benefit-generating activity associated with the redirected client request, so that process 400 creates its own records for use in crediting affiliate benefits to users. In some embodiments, such records may be compared to affiliate benefit data (e.g., commission data 180) from a web merchant to verify that the web merchant is properly tracking and awarding affiliate benefits. In one embodiment, process 400 may track subsequent affiliate-benefit-generating activity by remaining in the communication path between the source of the client request and the web merchant to which the client request was redirected, and recording pertinent data that passes between the web merchant and the source of the client request.

One of ordinary skill will recognize that stages may be added to, deleted from, reordered, and/or modified in process 400 without departing from the scope of the invention. For example, a stage may be added between stages 430 and 440, in which process 400 tracks subsequent activity associated with the client web page request after it is redirected to the web merchant, for the purpose of calculating commissions or other benefits. For another example, an additional stage may be added after stage 440, in which process 400 pays the user associated with the substitute link according to the credited amount of benefit-generating activity by, for example, sending a check or cash card to the user or transferring cash to the user via online banking or via an online payment transfer provider, such as PayPal™. For yet another example, an additional stage may be added after stage 440, in which process 400 pays a designee (such as a charity or a relative) specified by the user associated with the substitute link according to the credited amount of benefit-generating activity. For yet another example, stage 440 may be modified so that benefit-generating activity is credited to an entity that operates process 400, so that, for example, the entity is paid all or a portion of any commissions associated with substitute links created by a user. In one embodiment of this modification, the portion of commission paid to the entity is adjusted according to the volume of benefits earned from substitute links associated with a user.

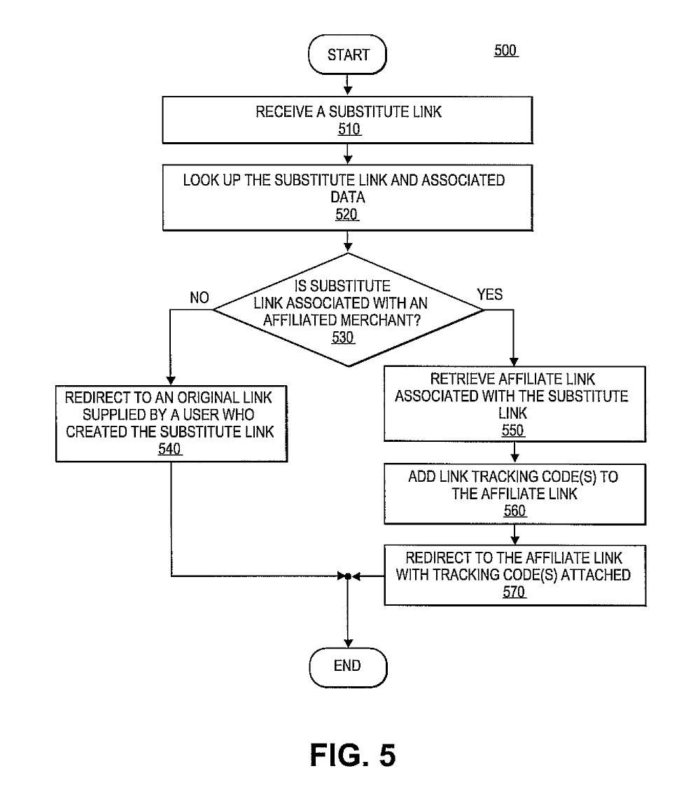

FIG. 5 is flow chart of another exemplary process 500 for utilizing a link for affiliate marketing consistent with embodiments of the invention. The embodiment illustrated in FIG. 5 provides additional details regarding implementing various steps of process 400 shown in FIG. 4. In certain embodiments, process 500 may be implemented using an intermediary website 130 in a system as shown in FIG. 1. In other embodiments, portions of process 500 may be implemented using a computing system not included in intermediary website 130.

As shown in FIG. 5, process 500 begins by receiving a substitute link, such as a substitute URL 140 (stage 510). In some embodiments, the substitute link may be received, for example, from an Internet user, (such as third party user 164), who clicked on the substitute link causing a browser to send a client request to a server associated with the substitute link, such as a server implementing intermediary website 130.

Next, process 500 looks up the received substitute link and data associated with the received substitute link (stage 520). In one embodiment, a set of substitute links and associated data, such as data representing an original link, an affiliate link, affiliated web merchant information, originating user information, etc., may be stored in a data structure, such as an ordered table or indexed list, that facilitates quick search and retrieval based on the substitute link.

Using the data associated with the substitute link, process 500 determines whether the substitute link is associated with an affiliated merchant (stage 530). In one embodiment, process 500 may check a specific field or parameter in a data structure entry corresponding to the substitute link to determine whether the substitute link is associated with an affiliated merchant.

If there is not an affiliated merchant associated with the substitute link (stage 530, No), then process 500 proceeds to stage 540. At stage 540, process 500 redirects the client request to a link, (such as original URL 120), supplied by a user, (such as user 100), who instigated the creation of the substitute link, (such as substitute URL 140). In one embodiment, process 500 retrieves the link supplied by the user from a data structure where it was stored when the user supplied it to create the substitute link.

If, on the other hand, there is an affiliated merchant associated with the substitute link (stage 530, Yes), then process 500 proceeds to stage 550. At stage 550, process 500 retrieves an affiliate link associated with the substitute link. In one embodiment, an affiliate link is a link that points to an affiliated merchant's website and allows the affiliated merchant to identify a specific registered affiliate as the provider of the link and to accurately pay to the registered affiliate any benefits (e.g., commissions) generated by internet users who use the affiliated link. In one embodiment, process 500 retrieves the affiliate link, such as affiliate URL 170, from a data structure where it was stored after creation during the substitute link creation process. For instance, a stored amazon.com affiliate link, containing a tag field that identifies the affiliate as “edeem-20” may be: “http://www.amazon.com/gp/product/B000H49LXQ?ie=UTF8&tag=edeem-20&linkCode=as2&camp=1789&creative=9325&creativeASIN=B000H49LXQ.”

In the embodiment of FIG. 5, process 500 next adds link tracking code(s) to the affiliate link (stage 560). In one embodiment, link tracking code(s) include a code that uniquely identifies an Internet user that utilizes the substitute link (e.g., third party user 164), and allows tracking of individual click activity by the Internet user and tracking of sales made via the click activity. For instance, using the “amazon.com” example, a tracking code “deem00123” may be assigned to the internet user who clicked on the substitute link and that code may be added to the affiliate link in a field or parameter called “tid” (tracking ID). In this example, the resulting affiliate link with tracking code may be: “http://www.amazon.com/gp/product/B000H49LXQ?ie=UTF8&tag=edeem-20&linkCode=as2&camp=1789&creative=9325&creativeASIN=B000H49LXQ&tid=deem00123.” In this example, because the affiliate link identifies “edeem-20” as the registered affiliate, the affiliated merchant (amazon.com) will credit any commissions generated from the use of the affiliate link to affiliate “edeem-20” and the commission data supplied by the affiliated merchant will include the tracking id associated with each commission-generating activity (in this case “deem00123”). By correlating the tracking id with the substitute link, and the substitute link with the user who caused its generation, the generating user can be properly credited with any earned commission.

At the last stage 570, process 500 redirects the entity that supplied the substitute link in stage 510, (e.g., third party user 164), according to the affiliate URL with the tracking code(s) attached. Subsequent commission-generating activity by the redirected entity on the affiliated merchant's website can be credited to the registered affiliate associated with process 500, and ultimately to the user that generated the substitute link, based on the tracking code(s).

As shown in the embodiment of FIG. 5, if the substitute link is not associated with an affiliated merchant (stage 530, No), then the substitute link does not provide any commission or other affiliate marketing program benefit due to third-party user activity on the linked-to website. In one embodiment consistent with the invention, the substitute-link-creating user may nonetheless benefit from the substitute link by associating the substitute link with a commission-generating ad such as a banner ad or an interstitutual ad or page. When the substitute link is distributed and shared with other internet users, the user may earn benefits when the substitute link is used and the associated ad is viewed and/or clicked on.

One of ordinary skill will recognize that stages may be added to, deleted from, reordered, and/or modified in process 500 without departing from the scope of the invention. For example, stage 550 may be modified such that process 500 generates the affiliate link as needed instead of retrieving a previously generated link from storage.

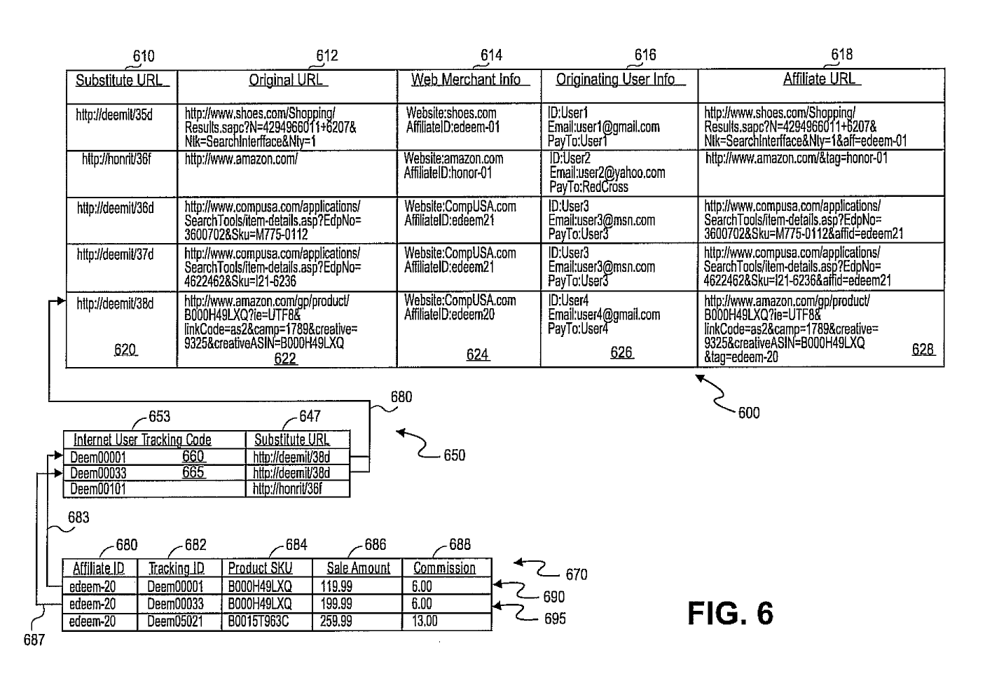

FIG. 6 illustrates exemplary data structures for organizing information related to an affiliate marketing link consistent with embodiments of the invention. In some embodiments, exemplary data structures 600, 650, and 670 may be implemented, and the data stored, on a server that hosts intermediary website 130.

FIG. 6 illustrates an exemplary originating-user-association data structure 600 that organizes data into five columns or fields or parameters. In other embodiments, the data may be organized in different ways using different types of data structures. In the embodiment shown, as users create additional substitute URLs, rows are added to data structure 600 to hold the substitute URLs and associated data. In the embodiment shown, the leftmost column 610 contains data representing substitute URLs created by systems and process consistent with the invention, for example, as may be created or generated as a type of substitute link in stage 230 of process 200 or in stage 380 of process 300 on behalf of a user 100.

The second column 612 contains data representing original URLs corresponding to the substitute URLs in column 610. In various embodiments, the original URLs in column 612 may be received from a user, an application program, or some other source, as described, for example, with respect to receiving a web merchant link in stage 210 of process 200 or stage 310 of process 300.

The third column 614 of data structure 600 contains information representing web merchants that are affiliated with systems and processes consistent with the invention. As shown, for example, in cell 624 of column 614, the web merchant information may include data identifying the web merchant's website, (such as “amazon.com”) and the affiliate ID, (such as “edeem-20”), assigned by the web merchant to an entity that registered with the web merchant's affiliate marketing program. The web merchant information may also include other data (not shown) related to the web merchant or the registered affiliate. In one embodiment, the web merchant information may include data describing web merchant website 110 and may be collected when an entity implementing systems and processes consistent with the invention, such as an entity managing intermediary website 130, is registered as an affiliate in the affiliate marketing program of a web merchant. In various embodiments, the web merchant information in column 612 may be utilized to determine whether a given web merchant is an affiliated merchant (i.e., a merchant whose affiliate marketing program has been joined) or whether a given merchant is similar to an affiliated merchant, as described with respect to stages 320, 330, and 350 of process 300.

The fourth column 616 of data structure 600 contains information representing originating users that utilize systems and processes consistent with the invention to create substitute links and participate in affiliate marketing programs. As shown, for example, in cell 626 of column 616, the originating user information may include a user ID (“User4”), a user email address (“user4@gmail.com”) and payment designee information (“User4”) that identifies to whom affiliate marketing program benefits, such as commissions, should be paid. The originating user information may also include other data related to the originating user (not shown). In one embodiment, the originating user information may be collected from a user, such as user 100, the first time that the user utilizes, or registers to use, systems and processes consistent with the invention.

The fifth column 618 of data structure 600 contains data representing affiliate URLs corresponding to the original URLs in column 612. In some embodiments, an affiliate URL, such as affiliate URL 170, in column 618 may be created as described with respect to creating an affiliate link during stage 340 of process 300.

As shown in exemplary data structure 600, a substitute URL, original URL, web merchant information, originating user information, and affiliate URL that are interrelated may all be associated with each other by placing them in the same row of data structure 600. For example, substitute URL 620, original URL 622, web merchant information 624, originating user information 626, and affiliate URL 628 are all associated with each other. Accordingly, a data structure such as data structure 600 may be used, for example, by stage 240 of process 200 or stage 390 of process 300, to associate and store related data items.

Similarly, after being populated, exemplary data structure 600 may be used to look up or identify web merchant information and links, as well as originating user information, associated with a substitute URL, for example, as described with respect to stage 420 of process 400 and with respect to stages 520-550 of process 500, by referencing the data in the row corresponding to the substitute URL. Similarly, exemplary data structure 600 may be used (for example, by redirect logic 135) to forward or direct an internet user employing a substitute URL, (such as third party user 164), to an affiliated web merchant's website, as described, for example, with respect to stage 430 of process 400 or stages 540, 560, and 570 of process 500.

FIG. 6 also illustrates an exemplary third-party-user-association data structure 650 that organizes data into two columns or fields. In the embodiment shown, as third party internet users utilize substitute links, rows are added to data structure 650 to record the use of the substitute URL and associated data. In other embodiments, similar data may be organized in different ways using different types of data structures. In the embodiment shown, the leftmost column 653 contains data representing a tracking code associated with an Internet user, (such as third party user 164), that utilizes a substitute URL or other substitute link. The second column 647 contains data representing the substitute URL used by the internet user, e.g., by clicking on a link corresponding to the substitute URL.

In one embodiment, a server associated with a website that a substitute URL points to (e.g., a server implementing redirect logic 135 on intermediary website 130) may assign a distinguishable tracking code (or in some embodiments, a unique tracking code) to each third party internet user that utilizes a substitute link, and record the tracking code and substitute link in a data structure, such as data structure 650. For example, with reference to FIG. 1 in conjunction with FIG. 6, third party user 162 may utilize substitute URL 140 (in this example, “http://deem.it/38d”) to interact with intermediary website 130, and intermediary website 130 may assign the tracking code “deem00001” to user 162 and record that assignment in cell 660 of data structure 650. In association with tracking code 660, intermediary website 130 may also record in the same row of data structure 650 the substitute URL used by user 162, which is “http://deem.it/38d” in this example.

Similarly, third party user 164 may utilize the same substitute URL 140 (“http://deem.it/38d”) to interact with intermediary website 130, and intermediary website 130 may assign the tracking code “deem00033” to user 164 and record that assignment in cell 665 of data structure 650. In association with tracking code 665, intermediary website 130 may also record in the second row of data structure 650 the substitute URL used by user 162, which is again “http://deem.it/38d.”

As explained elsewhere in this specification, for example with respect to stages 550, 560, and 570 of process 500, tracking codes 660 and 665 may be used to track the affiliate-benefit-generating activities of third party users 162 and 164, respectively, and to properly credit the generated benefits (such as referral fees or referral discounts) to the user who instigated creation of the substitute URL utilized by third party users 162 and 164 (“http://deem.it/38d” in this example). As explained in greater detail below, in various embodiments, a substitute URL 647 from data structure 650 may be used as a pointer, index or other access means 680 into data structure 600 to look up or find data, such as originating user information 626, that is stored in association with the substitute URL.

FIG. 6 also illustrates an exemplary affiliate-benefits data structure 670 that organizes affiliate benefit data, such as commission data 180, from a web merchant. In the example shown in FIG. 6, data structure 670 organizes benefit data into five columns or fields. In the embodiment shown, as affiliate benefit data is obtained from a web merchant, rows are added to data structure 670 to record the data in a convenient manner. In other embodiments, the benefit data may be organized in different ways using different types of data structures. In the embodiment shown, the leftmost column 680 contains data representing an affiliate ID assigned to an entity, such as intermediary website 130, that is registered as an affiliate in an affiliate marketing program offered by a web merchant. The second column 682 contains data representing a tracking ID provided in an affiliate link used by a third party internet user who generated affiliate marketing benefits on the web merchant's website, such as website 110. In one embodiment, tracking ID 682 is equivalent to, or otherwise corresponds to, tracking code 653 The third column 684 contains data representing a product or service, such as a stock control unit (SKU) number, that was purchased by a third party user. The fourth column 686 contains data representing a sale amount, or sale price, paid by a third party user to purchase the product or service described in column 684. And, the last column 688 contains data representing a commission (or other benefit) earned by the affiliate, which may be based, for example, on the sale amount 686.

In various embodiments, data structure 670 may be used to credit affiliate benefits, such as commissions 688, to the appropriate originating user of a substitute link as explained, for example, with respect to stage 440 of process 400. For instance, a computing system, such as a server implementing intermediary website 130, may process the first row 690 of data structure 670 to identify the tracking ID 682 of the internet user who generated commission 688. In this example, the tracking ID is “Deem00001.” Using the tracking ID as an index or pointer 683 into data structure 650, the computing system may identify the substitute URL 657 associated with the data in row 690 of data structure 670. In this example, the corresponding substitute URL is “htpp://deem.it/38d.” Then, as noted previously, the substitute URL 657 may be used to access 680 the appropriate row of data structure 600 and find the originating user information 616 that is associated with the substitute URL. In this example, substitute URL 620 “htpp://deem.it/38d” is associated with user “User4,” as indicated in cell 626. According to this embodiment, user “User4” is credited with the $6.00 commission listed in row 690 of data structure 670. Following a similar process, as shown by path 687 and 680 of FIG. 6, user “User4” is also credited with the $6.00 commission shown in row 695 of data structure 670.

In some embodiments, originating user information 616 may include information regarding to whom commissions, or other earned affiliate benefits, are to be paid. Continuing the example above, “User4” has specified in the “PayTo” attribute that User4 will receive their own earned commissions. For another example, in the second row of column 616, “User2” has specified that any earned benefits are to be paid to the Red Cross charitable organization. In some embodiments, a user may specify that portions of earned benefits are to be paid to two or more entities, for example 50 percent to the originating user and 50 percent to a charitable organization.

One of ordinary skill will recognize the data structures of FIG. 6 may be organized differently, and may be implemented using various databases or programming techniques, without departing from the principles of the invention. For example, the three data structures 600, 650, and 670 may be combined into a single data structure or database. In addition, data structures 600, 650, and 670 may contain additional or fewer data items, without departing from the principles of the invention. For example, data structure 600 may have another column that is used to track the total amount of commission accumulated by a user, another column that records reporting data, and/or added information in the web merchant information column 614, such as information regarding merchant type and classification that may be used to identify similar merchants. For another example, additional information specifying more than one “PayTo” designees and a percentage portion of earned benefits to be paid to each, may be added to originating user information 616 of data structure 600. For yet another example, columns 684 and 686 may be removed from data structure 670.

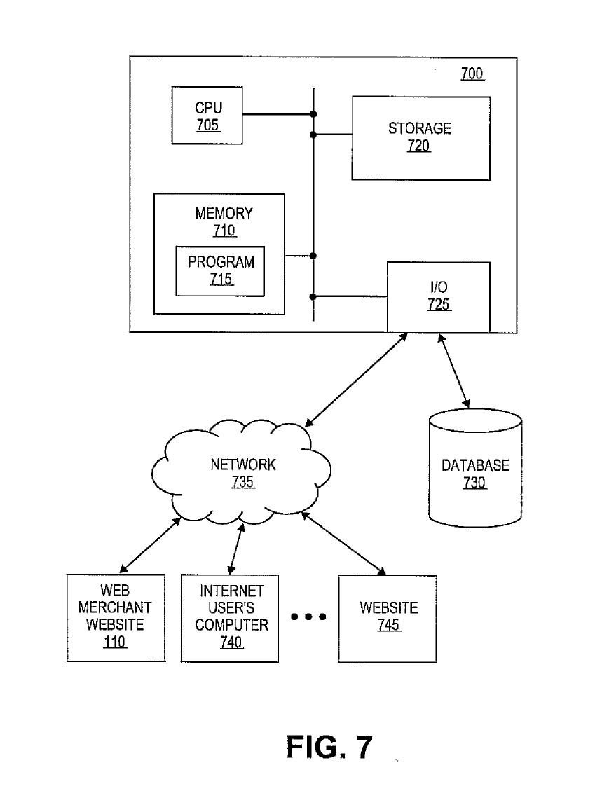

FIG. 7 is a block diagram of an exemplary computing system 700 that may be used to implement embodiments consistent with the invention. The exact components and arrangement, however, are not critical to the invention. Data computing system 700 includes a number of components, such as a central processing unit (CPU) 705, a memory 710, an input/output (I/O) device(s) 725, and a nonvolatile storage device 720. System 700 can be implemented in various ways. For example, an implementation as an integrated platform (such as a workstation, personal computer, laptop, etc.) may comprise CPU 705, memory 710, nonvolatile storage 720, and I/O devices 725. In such a configuration, components 705, 710, 720, and 725 may connect and communicate through a local data bus and may access a database 730 (implemented, for example, as a separate database system) via an external I/O connection. I/O component(s) 725 may connect to external devices through a direct communication link (e.g., a hardwired or local wifi connection), through a network, such as a local area network (LAN) or a wide area network (WAN) and/or through other suitable connections. System 700 may be standalone or it may be a subsystem of a larger system, such as a larger system for providing affiliate marketing benefits to users without requiring the users to have a website or join a web merchant's affiliate marketing program.

CPU 705 may be one or more known processing devices, such as a microprocessor from the Core™ 2 family manufactured by Intel™ Corporation. Memory 710 may be one or more fast storage devices configured to store instructions and information used by CPU 705 to perform certain functions and processes related to embodiments of the present invention. Storage 720 may be a volatile or non-volatile, magnetic, semiconductor, tape, optical, or other type of storage device or computer-readable medium, including devices meant for long-term storage.

In the illustrated embodiment, memory 710 contains one or more programs or subprograms 715 loaded from storage 720 that, when executed by CPU 705, perform various procedures, processes, or methods consistent with the present invention. Alternatively, CPU 705 may execute one or more programs located remotely from system 700. For example, system 700 may access one or more remote programs that, when executed, perform functions and processes related to embodiments of the present invention.

In one embodiment, memory 710 may include an affiliate marketing benefits computer program 715 that controls a website, such as intermediary website 130, to direct substitute links to a web merchant's website, such as redirect logic 135. Memory 710 may also include other programs that implement other methods and processes that provide affiliate marketing functionality to users who do not personally belong to an affiliate marketing program and/or do not have their own websites, such as programs that provide registration functions, substitute link generation functions, commission tracking functions, payment functions, designee payment functions, and other functions to users.

Methods and systems consistent with the invention are not limited to programs or computers configured to perform dedicated tasks. For example, memory 710 may be configured with a program 715 that performs several functions when executed by CPU 705. For example, memory 710 may include a single program 715 that registers users, generates substitute links, accepts substitute links and directs them to web merchants, accepts commission data from web merchants, and separates and pays commissions to the users who earned them.

Memory 710 may be also be configured with other programs (not shown) unrelated to the invention and/or an operating system (not shown) that performs several functions well known in the art when executed by CPU 705. By way of example, the operating system may be Microsoft Windows™, Unix™, Linux™, an Apple Computers™ operating system, Personal Digital Assistant operating system such as Microsoft CE™, or other operating system. The choice of operating system, and even to the use of an operating system, is not critical to the invention.

I/O device(s) 725 may comprise one or more input/output devices that allow data to be received and/or transmitted by system 700. For example, I/O device 725 may include one or more input devices, such as a keyboard, touch screen, mouse, and the like, that enable data to be input from a user, such as a system operator. Further, I/O device 525 may include one or more output devices, such as a display screen, CRT monitor, LCD monitor, plasma display, printer, speaker devices, and the like, that enable data to be output or presented to a user. I/O device 725 may also include one or more digital and/or analog communication input/output devices that allow computing system 700 to communicate, preferably digitally, with other machines and devices. The configuration and number of input and/or output devices incorporated in I/O device 725 are not critical to the invention.

In the embodiment shown, system 700 connects via a network 735, (such as the Internet), to various systems and computing machines, such as web merchant website 110, an Internet user's computer 740, and other websites 745 connected to network 735. In general, system 700 may input data from external machines and devices and output data to external machines and devices via network 735, and other entities in addition to those shown may connect to network 735 and interact with system 700.

In the exemplary embodiment shown in FIG. 7, database 730 is a standalone database external to system 700. In other embodiments, database 730 may be hosted by system 700. In various embodiments, database 730 may manage and store data used to implement systems and methods consistent with the invention. For example, database 730 may manage and store data structures used to record user information and links (such as substitute links and affiliate links) created by users, record link usage by third party Internet users, and record and reconcile affiliate benefit data, such as commission data.

Database 730 may comprise one or more databases that store information and are accessed and/or managed through system 700. By way of example, database 730 may be an Oracle™ database, a Sybase™ database, or other relational database. In various embodiments, database 730 may be used to manage and store, for example, data organized as shown in data structures 600, 650 and 670 of FIG. 6. Systems and methods consistent with the invention, however, are not limited to separate data structures or databases, or even to the use of a database or data structure.

Other embodiments of the invention will be apparent to those skilled in the art from consideration of the specification and practice of the invention disclosed herein. It is intended that the specification and examples be considered as exemplary only, with a true scope of the invention being indicated by the following claims.

What is claimed is:

1. A method for affiliate marketing comprising:
registering an intermediary entity as an affiliate in an affiliate marketing program of a business;
obtaining, from a user, a link that links to a website of the business;
creating a substitute link for the link, wherein the substitute link links to an intermediary website associated with the intermediary entity;
directing, by the intermediary website and to the website of the business, a client request initiated using the substitute link; and
crediting to the user, by the intermediary entity, an affiliate benefit earned in conjunction with the directing according to the affiliate marketing program.

2. The method of claim 1, further comprising:
providing the substitute link to the user.

3. The method of claim 1, further comprising:
tracking an affiliate-benefit-earning activity associated with the client request after the directing.

4. The method of claim 1, wherein crediting comprises:
obtaining benefit data from the business, wherein the benefit data includes a plurality of affiliate benefits earned by the intermediary entity;
processing the benefit data to determine the affiliate benefit associated with the directing; and
providing the affiliate benefit to the user.

5. The method of claim 1, wherein directing further comprises:
creating an affiliate link that is associated with the substitute link, wherein the affiliate link identifies the intermediary entity as the affiliate; and
forwarding the client request to the website of the business using the affiliate link.

6. The method of claim 5, further comprising:
adding a tracking code associated with the substitute link to the affiliate link.

7. The method of claim 1, wherein crediting further comprises:
receiving, from the user, a designation of an entity to receive the affiliate benefit; and
crediting the affiliate benefit to the entity.

8. The method of claim 1, wherein crediting further comprises:
crediting a first portion of the affiliate benefit to the user; and
crediting a second portion of the affiliate benefit to the intermediary entity.

9. The method of claim 1, further comprising:
paying the affiliate benefit to the user;
wherein the affiliate benefit is one of a group consisting of cash and a cash equivalent.

10. A method for enabling a user to participate in an affiliate marketing program of a web business comprising:
creating an affiliate to the web business according to the affiliate marketing program, wherein the affiliate includes an intermediary website;
supplying a substitute link that links to the intermediary website, wherein the substitute link is associated with the user and with the web business;
forwarding, by the intermediary website, a client that is using the substitute link to the web business;
receiving, by the affiliate and from the web business, an affiliate benefit generated in association with the forwarding of the client; and
attributing the affiliate benefit to the user that is associated with the substitute link.

11. The method of claim 10, wherein receiving comprises:
obtaining benefit data from the web business that includes a plurality of affiliate benefits earned by the affiliate; and
wherein attributing comprises:
processing the benefit data to determine the affiliate benefit associated with the substitute link; and
attributing the affiliate benefit to the user associated with the substitute link.

12. The method of claim 10, wherein forwarding comprises:
creating an affiliate link that is associated with the substitute link, wherein the affiliate link identifies the affiliate to the web business; and
forwarding the client to the web business using the affiliate link.

13. The method of claim 12, wherein the affiliate link further comprises:
a tracking identifier that is associated with the substitute link and the user.

14. The method of claim 10, wherein attributing further comprises:
determining the substitute link used by the client;
determining the user that is associated with the substitute link; and
crediting the affiliate benefit to the user that is associated with the substitute link.

15. The method of claim 10, wherein attributing comprises:
distributing the affiliate benefit to a designee specified by the user.

16. The method of claim 10, wherein attributing comprises:
distributing a portion of the affiliate benefit to the affiliate.

17. The method of claim 10, wherein attributing comprises:
sending, to the user, one of a group consisting of cash in an amount equal to at least a portion of the affiliate benefit and a cash equivalent in an amount equal to at least a portion of the affiliate benefit.

18. A method for affiliate marketing comprising:
obtaining a link that links to a website of a business;
providing the link and information identifying an originating user to an affiliate of the business, wherein the affiliate includes an intermediary website;
receiving from the affiliate a substitute link that links to the intermediary website, wherein the substitute link is associated with the originating user;
distributing the substitute link to an Internet user; and
receiving, from the affiliate, credit for an affiliate benefit caused by the internet user utilizing the substitute link to interact with the website of the business;
wherein the originating user is not the affiliate of the business.

19. The method according to claim 18, further comprising:
providing information identifying the originating user to the affiliate; and
receiving, by the originating user according the information, at least a portion of the affiliate benefit.

20. The method according to claim 18, further comprising:
providing information identifying a designated beneficiary of to the affiliate; and
authorizing delivery of at least a portion of the affiliate benefit to the designated beneficiary.
